(19) United States
(12) Patent Application Publication
(10) Pub. No.: US 2021/0004355 A1
(43) Pub. Date: Jan. 7, 2021

(54) DISTRIBUTED STORAGE SYSTEM, DISTRIBUTED STORAGE SYSTEM CONTROL METHOD, AND STORAGE MEDIUM

(71) Applicant: HITACHI, LTD., Tokyo (JP)

(72) Inventor: Hiromichi IWASE, Tokyo (JP)

(73) Assignee: HITACHI, LTD., Tokyo (JP)

(21) Appl. No.: 16/809,710

(22) Filed: Mar. 5, 2020

(30) Foreign Application Priority Data
Jul. 4, 2019 (JP) 2019-125402

(51) Int. Cl. G06F 16/14; G06F 16/174; G06F 16/182; G06F 16/27; G06F 9/50

(52) U.S. Cl. CPC G06F 16/152; G06F 16/156; G06F 9/5016; G06F 16/1824; G06F 16/278; G06F 16/1752

(57) ABSTRACT

A distributed storage system includes a physical chunk management module, a logical chunk management module, a volume management module and a pair management module. The physical chunk management module is configured to manage physical chunks obtained by dividing a physical storage area of the storage device by a predetermined size. The logical chunk management module is configured to manage, as each of logical chunks, a logical storage area to which one or more physical chunks among the physical chunks is allocated. The volume management module is configured to provide a volume to which one or more logical chunks among the logical chunks is allocated, to outside. The pair management module is configured to manage, as a pair, the logical chunks storing the same data among the plurality of nodes.

### CLAIM OF PRIORITY

The present application claims priority from Japanese patent application JP 2019-125402 filed on Jul. 4, 2019, the content of which is hereby incorporated by reference into this application.

### BACKGROUND

This invention relates to a distributed storage system configured to store data in a plurality of nodes.

As technologies for processing large-scale data, distributed processing systems including a HADOOP are widely used. Meanwhile, as technologies for storing a large amount of data, a distributed storage system and a software defined storage (SDS) are known.

As an example of the distributed storage system, there is known JP 2011-159142 A. In JP 2011-159142 A, there is disclosed a technology for providing a deduplication function and a distributed redundant arrangement function in a hierarchical structure and preventing a plurality of identical blocks from being stored, to thereby improve data storage efficiency.

### SUMMARY

The above-mentioned distributed processing systems including a HADOOP include a system having a redundancy function. In the system, data acquired by one node is transferred to other nodes as well, and the same data is held by a plurality of nodes.

When the distributed processing system having a redundancy function is combined with the SDS or the distributed storage system, the redundancy function of the distributed storage system and the redundancy function of the distributed processing system are superimposed on each other, and one piece of data is held by a large number of nodes. In regard to an increase in redundancy level, an excessive increase in redundancy level can be suppressed by employing JP 2011-159142 A described above.

In order for the distributed processing system to perform processing at high speed, it is desired that data be stored locally in a node of the distributed storage system to be accessed by the distributed processing system. However, the above-mentioned related art has a problem in that the data cannot be guaranteed to be stored in the node of the distributed storage system to be accessed by the distributed processing system.

Therefore, this invention has been made in view of the above-mentioned problem, and has an object to process access from a distributed processing system at high speed while preventing an excessive increase in redundancy level.

According to one aspect of the present invention, a distributed storage system includes a plurality of nodes coupled to each other, the plurality of nodes each including a processor, a memory, a storage device, and a network interface. The distributed storage system includes a physical chunk management module, a logical chunk management module, a volume management module and a pair management module. The physical chunk management module is configured to manage physical chunks obtained by dividing a physical storage area of the storage device by a predetermined size. The logical chunk management module is configured to manage, as each of logical chunks, a logical storage area to which one or more physical chunks among the physical chunks is allocated. The volume management module is configured to provide a volume to which one or more logical chunks among the logical chunks is allocated, to outside. The pair management module is configured to manage, as a pair, the logical chunks storing the same data among the plurality of nodes. The volume management module is configured to identify, when a write request for the data is received, one of the logical chunks that forms a designated volume, and transmit, to the logical chunk management module, an instruction to write the data to the identified one of the logical chunks. The logical chunk management module is configured to identify one of the physical chunks that forms the one of the logical chunks, and transmit, to the physical chunk management module, an instruction to write the data to the one of the physical chunks. The physical chunk management module is configured to write the data to the identified one of the physical chunks. The pair management module is configured to calculate a hash value of the data, transmit the hash value to another node, and issue a query about presence or absence of the same hash value.

Therefore, according to at least one embodiment of this invention, it is possible to achieve high-speed processing by processing access from the distributed processing system by the local node while preventing an excessive increase in redundancy level in the distributed storage system.

The details of at least one embodiment of the subject matter disclosed herein are described in the following description with reference to the accompanying drawings. Other features, aspects, and effects of the presently disclosed subject matter become apparent below from the following disclosure, the drawings, and the claims.

### BRIEF DESCRIPTION OF THE DRAWINGS

FIG. 1 is a block diagram for illustrating an example of a distributed storage system according to a first embodiment of this invention.

FIG. 2 is a block diagram for illustrating an example of a software configuration of the storage node according to the first embodiment of this invention.

FIG. 3 is a diagram for illustrating an example of a storage area obtained by combining the distributed processing system and the distributed storage system with each other according to the first embodiment of this invention.

FIG. 4 shows an example of tables to be used by the distributed storage system according to the first embodiment of this invention.

FIG. 5 shows an example of the volume management table according to the first embodiment of this invention.

FIG. 6 shows an example of the chunk management table according to the first embodiment of this invention.

FIG. 7 shows an example of the logical chunk management table according to the first embodiment of this invention.

FIG. 8 shows an example of the physical chunk management table according to the first embodiment of this invention.

according to a first embodiment of this invention.

FIG. 9 is a sequence diagram for illustrating an example of processing for generating a volume, which is performed by the storage node according to the first embodiment of this invention.

FIG. 10 is a diagram for illustrating an example of write processing and redundancy processing, which are performed in the storage node according to the first embodiment of this invention.

FIG. 11 is an example of the chunk management table obtained by the redundancy processing according to the first embodiment of this invention.

FIG. 12 is the former half of a sequence diagram for illustrating detailed processing of the write processing and redundancy processing according to the first embodiment of this invention

FIG. 13 is the latter half of a sequence diagram for illustrating detailed processing of the write processing and redundancy processing according to the first embodiment of this invention.

FIG. 14 is a diagram for illustrating an example of update processing to be performed in the storage node according to the first embodiment of this invention.

FIG. 15 shows an example of the logical chunk management table according to the first embodiment of this invention.

FIG. 16 shows an example of the chunk management table according to the first embodiment of this invention.

FIG. 17 is a sequence diagram for illustrating an example of update processing to be performed in the storage node according to the first embodiment of this invention.

FIG. 18 is a diagram for illustrating an example of read processing to be performed by the storage node according to the first embodiment of this invention.

FIG. 19 is a sequence diagram for illustrating an example of read processing to be performed in the storage node according to the first embodiment of this invention.

FIG. 20 is a diagram for illustrating an example of the read processing at a failure occurrence according to the first embodiment of this invention.

FIG. 21 shows an example of the chunk management table according to the first embodiment of this invention.

FIG. 22 shows an example of the logical chunk management table according to the first embodiment of this invention.

FIG. 23 is a sequence diagram for illustrating an example of the read processing to be performed in the storage node when a failure occurs according to the first embodiment of this invention.

FIG. 24 is a block diagram for illustrating an example of a distributed storage system according to a second embodiment of this invention.

FIG. 25 is a block diagram for illustrating an example of the software configuration of the HCI node according to the second embodiment of this invention.

### DETAILED DESCRIPTION OF THE PREFERRED EMBODIMENTS

Embodiments of this invention are described below with reference to the accompanying drawings. In the following description, like components are denoted by like reference symbols.

### [First Embodiment]

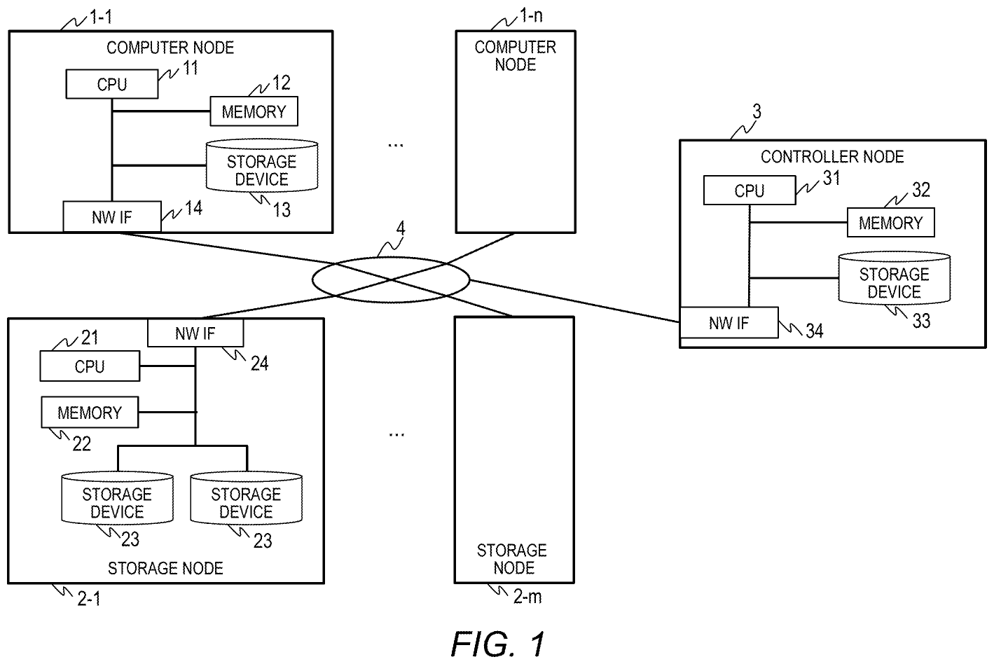

FIG. 1 is a block diagram for illustrating an example of a distributed storage system according to a first embodiment of this invention. The description of the first embodiment is directed to an example of a computer system in which a distributed processing system uses a distributed storage system.

The computer system includes computer nodes 1-1 to 1-n forming a distributed processing system, storage nodes 2-1 to 2-m forming a distributed storage system, a controller node 3 configured to manage the distributed storage system, and a network 4 configured to couple the respective nodes to one another.

In the following description, the reference numeral “2” with the sign “-” and the subsequent part being omitted is used unless each individual storage node is identified. The same applies to the reference symbols of the other components.

A distributed processing system including a redundancy function, for example, a HADOOP and a mongoDB, operates in the computer node 1. The computer nodes 1-1 to 1-n have the same configuration, and hence the computer node 1-1 is representatively described below, while the descriptions of the other computer nodes are omitted.

The computer node 1-1 is a computer including a CPU 11, a memory 12, a storage device 13, and a network interface 14. A distributed processing program including a redundancy function is loaded into the memory 12 to be executed by the CPU 11. The network interface 14 is coupled to the network 4 to communicate to/from another node.

A distributed storage system operates in the storage node 2. The storage nodes 2-1 to 2-m have the same configuration, and hence the storage node 2-1 is representatively described below, while the descriptions of the other storage nodes are omitted.

The storage node 2-1 is a computer including a CPU 21, a memory 22, storage devices 23, and a network interface 24. A distributed storage program is loaded into the memory 22 to be executed by the CPU 21. The network interface 24 is coupled to the network 4 to communicate to/from another node.

In the storage node 2, a software defined storage (SDS) may be operated instead of the distributed storage system.

The controller node 3 is a computer including a CPU 31, a memory 32, a storage device 33, and a network interface 34. A management program for managing the distributed storage system is loaded into the memory 32 to be executed by the CPU 31. The network interface 34 is coupled to the network 4 to communicate to/from the storage node 2.

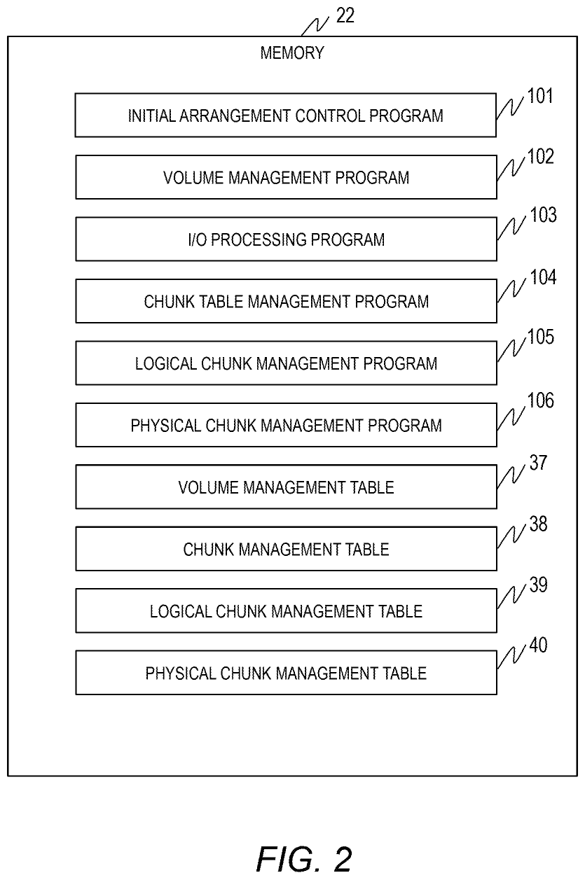

FIG. 2 is a block diagram for illustrating an example of a software configuration of the storage node 2. The memory 22 of the storage node 2 stores programs and tables that form the distributed storage system.

The programs stored in the distributed storage system include an initial arrangement control program 101, a volume management program 102, an I/O processing program 103, a chunk table management program 104, a logical chunk management program 105, and a physical chunk management program 106. The tables include a volume management table 37, a chunk management table 38, a logical chunk management table 39, and a physical chunk management table 40.

The initial arrangement control program 101 performs processing for allocating a storage area of the storage device 23 to a volume in response to a request received from the computer node 1 using the distributed storage system. The volume management program 102 generates, migrates, or deletes a volume to be provided to the computer node 1 in response to a request received from the initial arrangement control program 101 or the controller node 3.

The I/O processing program 103 controls reading from and writing to a cache and the storage device 23. The chunk table management program 104 manages logical chunks that store the same data between the storage nodes 2 as a copy pair (backup data) by associating the logical chunks with a hash value of the data. The chunk table management program 104 functions as a management module for paired data.

The storage node 2 in the first embodiment manages an area obtained by dividing a physical storage area of the storage device 23 by a predetermined size (capacity), in physical measurement units called “physical chunks (PChunks)”. The storage node 2 also manages a logical storage area to which one or more physical chunks is allocated, in logical management units called logical chunks (LChunks). Then, the storage node 2 provides the logical storage area to which one or more logical chunks is allocated, to the computer node 1 as a volume.

The logical chunk management program 105 executes management of access to the logical chunk and its configuration. The physical chunk management program 106 executes management of access to the physical chunk and its configuration.

The CPU 21 operates as a functional module configured to provide a predetermined function by performing processing in accordance with a program of each functional module. For example, the CPU 21 functions as a chunk table management module (or pair management module) by performing processing in accordance with the chunk table management program 104. The same applies to the other programs. The CPU 21 also operates as a functional module configured to provide each function of a plurality of processes to be executed by each program. The computers and the computer systems are apparatus and systems including those functional modules.

The volume management table 37 is used to manage a relationship between each logical chunk and each volume. The chunk management table 38 is used to manage, as a copy pair, a logical chunk of one storage node 2 and a logical chunk of another storage node 2 that have the same data. The logical chunk management table 39 is used to manage physical chunks allocated to logical chunks. The physical chunk management table 40 is used to manage a physical storage location by an identifier of the storage device 23 and an address in the storage device 23. Each table is described later in detail.

<Outline of Storage Area>

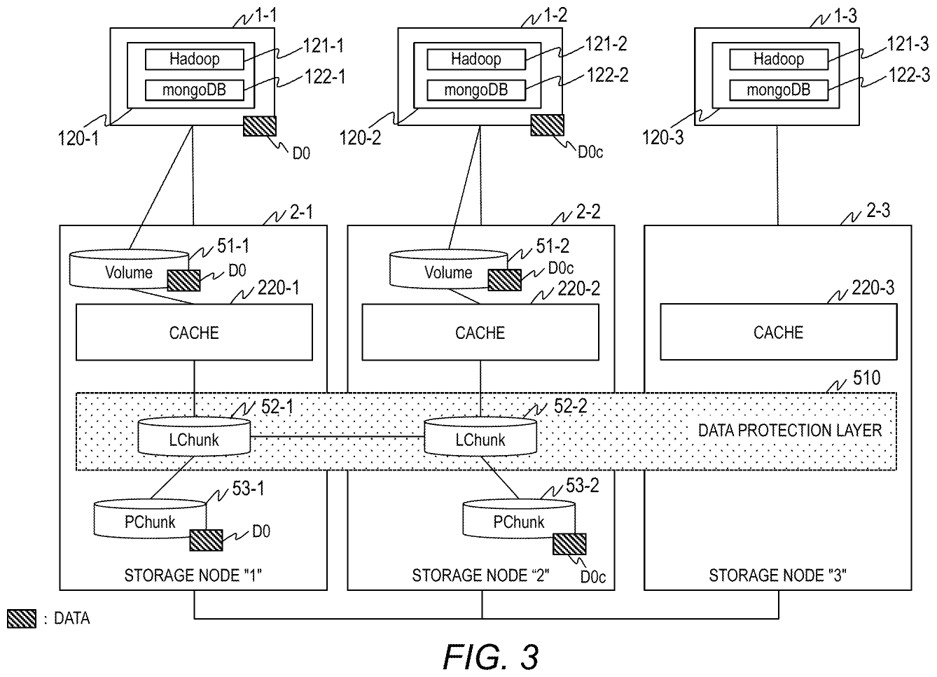

FIG. 3 is a diagram for illustrating an example of a storage area obtained by combining the distributed processing system and the distributed storage system with each other.

The example illustrated in FIG. 3 is an example in which three storage nodes 2-1 to 2-3 and computer nodes 1-1 to 1-3 are combined with each other. In the computer node 1, a distributed processing system 120 including a HADOOP 121 and a mongoDB 122 operates as a distributed processing system including a redundancy function.

The description of the first embodiment is directed to a case in which the redundancy level of the distributed processing system 120 is set to 2. First, the computer node 1-1 receives data D0 from the outside, and writes the data D0 to the storage node 2-1 allocated to the computer node 1-1. The distributed processing system 120 of the computer node 1-1 transmits a replica (data D0c) of the data D0 to another computer node 1-2 based on the redundancy level.

The storage node 2-1 writes the data D0 received from the computer node 1-1 to a cache 220-1 of a local volume 51-1, and then writes the data D0 to a logical chunk 52-1 and a physical chunk 53-1 allocated to the volume 51-1.

The storage node 2-1 writes data to a local volume 51 (physical chunk 53) in response to a write request received from the computer node 1-1 to which the relevant storage node 2-1 is allocated, to thereby be able to reduce access latency to achieve an increase in processing speed of the distributed processing system 120.

Meanwhile, the computer node 1-2 that has received the data D0c obtained by replicating the data D0 writes the data D0c to the storage node 2-2 allocated to the computer node 1-2.

The storage node 2-2 writes the data D0c received from the computer node 1-2 to a cache 220-2 of a volume 51-2, and then writes the data D0c to a logical chunk 52-2 and a physical chunk 53-2 allocated to the volume 51-2.

The storage nodes 2 share the chunk management table 38 for managing data stored in a logical chunk 52 to detect the same data present between the storage nodes 2 as a redundancy pair and manage the same data based on the chunk management table 38.

The storage node 2-1 calculates a hash value of the data D0 newly written to the logical chunk 52-1, and writes the hash value to its own chunk management table 38. The storage node 2-2 also calculates a hash value of the data D0c newly written to a logical chunk 52-2, and writes the hash value to its own chunk management table 38. The storage node 2 may calculate the hash value at a timing asynchronous with write processing, and it suffices that the timing is a predetermined timing, for example, a predetermined cycle or a timing at which a load on the CPU 21 is low.

Then, the storage nodes 2 exchange the hash values in the chunk management table 38 with each other, and when the same data is present, exchange the identifiers of the logical chunks storing the relevant data. Then, the storage nodes 2 write the identifiers to the chunk management tables 38 of the respective storage nodes 2, and manage the identifiers as a copy pair.

The storage nodes 2 have a data protection layer 510 for detecting data written based on the redundancy level of the distributed processing system 120 through use of the chunk management table 38 and managing the data as a copy pair (or backup data).

The storage node 2-1 writes the hash value of the written data D0 to the chunk management table 38, and then notifies the other storage nodes 2-2 to that effect. The storage node 2-2 also writes the hash value of the written data D0c to the chunk management table 38, and then notifies the other storage nodes 2-1 to that effect.

The storage node 2-2 has the data D0c including the same hash value as that of the data D0, and hence the storage node 2-2 notifies the storage node 2-1 of the identifier of the logical chunk 52-2 storing the data D0c.

The storage node 2-1 stores the identifier of the logical chunk 52-2 received from the storage node 2-2 in the chunk management table 38 as the identifier of the logical chunk storing data that forms a copy pair with the data D0. This allows the data D0 stored in the logical chunk 52-1 of the storage node 2-1 and the data D0c stored in the logical chunk 52-2 of the storage node 2-2 to be detected as a copy pair and to be held by the chunk management table 38.

In the same manner as described above, the storage node 2-2 also stores the identifier of the logical chunk 52-1 received from the storage node 2-1 in the chunk management table 38 as the identifier of the logical chunk storing data that forms a copy pair with the data D0c.

As described above, the storage node 2 in the first embodiment does not have redundancy at first when data is written, but detects and manages a copy pair corresponding to the redundancy level of the distributed processing system 120 in the layer of the logical chunk 52 (in the data protection layer 510). This allows the storage node 2 to ensure redundancy without achieving redundancy on the distributed storage system side, and to prevent the redundancy level from becoming excessive.

In addition, the storage node 2-1 always writes data to the local volume 51 (physical chunk 53) in response to a write request received from the computer node 1-1 to which the relevant storage node 2-1 is allocated, to thereby achieve an increase in processing speed of the distributed processing system 120.

When setting the copy pair of the logical chunks 52, the storage node 2 verifies that the data in the logical chunk 52 of the storage node 2 matches the data in the logical chunk 52 of the other storage node 2 in consideration of a collision between the hash values.

In addition, the storage node 2 in the first embodiment is configured so that the physical chunk 53-1 allocated to the logical chunk 52-1 is set in the same storage node 2. In other words, the physical chunk 53 is inhibited from being allocated across the storage nodes 2, to thereby be able to prevent the performance of the storage node 2 from deteriorating.

<Tables>

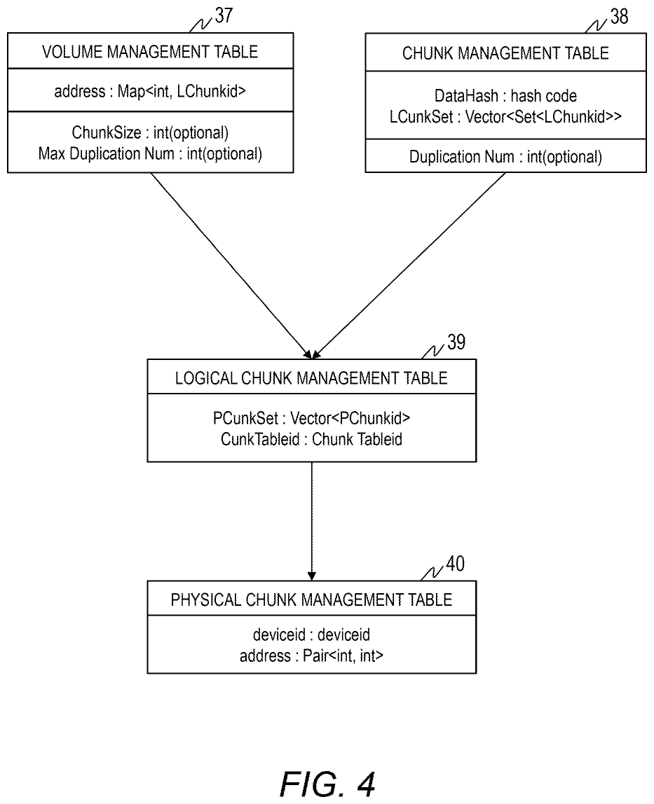

FIG. 4 shows an example of tables to be used by the distributed storage system. The storage node 2 of the distributed storage system manages the storage location of data based on the volume management table 37, the logical chunk management table 39, and the physical chunk management table 40.

The storage nodes 2 also form the data protection layer 510 for detecting the same data based on the chunk management table 38 and setting a copy pair.

The volume management table 37 is used to manage a relationship between each volume and each logical chunk. The logical chunk management table 39 is used to manage a relationship between each logical chunk and each physical chunk. The physical chunk management table 40 is used to manage the physical storage location by the identifier of the storage device 23 and the address in the storage device 23.

The chunk management table 38 is used to manage a relationship among the hash value of data stored in a logical chunk, the storage node 2 storing the relevant data, and the logical chunk.

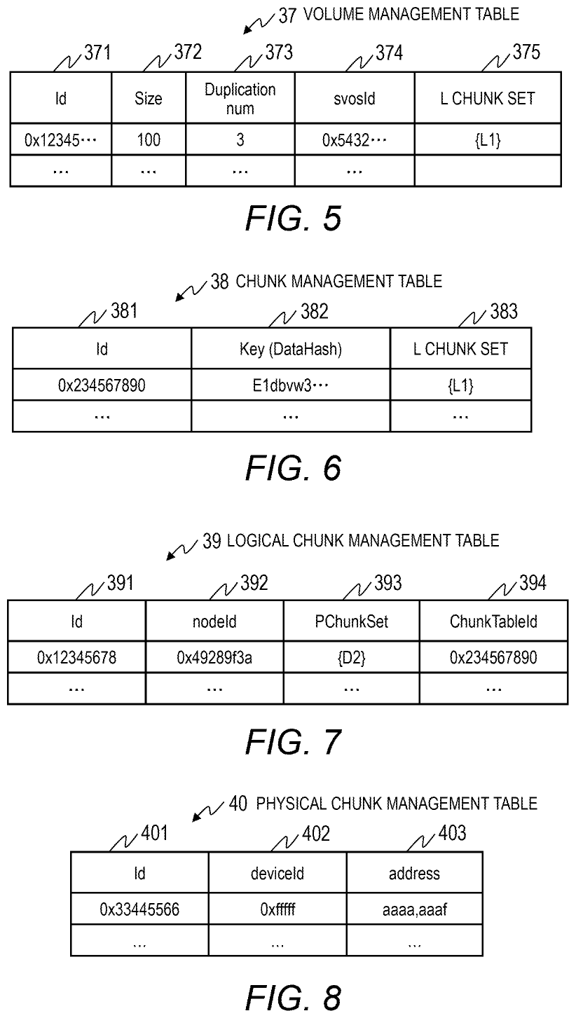

FIG. 5 shows an example of the volume management table 37. The volume management table 37 includes, in one entry, an Id 371 for storing the identifier of a volume, a Size 372 for storing the capacity of the volume, a Duplication num 373 for storing the number of replicas, a svosId 374 for storing the identifier of an OS of the storage node 2, and an L chunk set 375 for storing the identifier of a logical chunk allocated to the relevant volume.

The volume management table 37 is used to manage a relationship among one or more logical chunks allocated to the identifier of the volume based on the L chunk set 375. When the redundancy function is not used on the storage node 2 side, the Duplication num 373 is set to “0”.

FIG. 6 shows an example of the chunk management table 38. The chunk management table 38 includes, in one entry, an Id 381 for storing the identifier of each entry, a Key (DataHash) 382 for storing the hash value of data stored in a logical chunk, and an L chunk set 383 for storing the identifier of a logical chunk for storing the same data.

The L chunk set 383 stores the identifiers of one or more logical chunks. The identifier of the logical chunk uses a value unique in the distributed storage system. The L chunk set 383 stores the identifiers of the logical chunks storing the same data (copy pair), and the chunk management table 38 functions as a pair management table.

FIG. 7 shows an example of the logical chunk management table 39. The logical chunk management table 39 includes, in one entry, an Id 391 for storing the identifier of a logical chunk, a nodeId 392 for storing the identifier of the storage node 2 storing the logical chunk, a PChunkSet 393 for storing the identifier of a physical chunk holding the content of the logical chunk, and a ChunkTableId 394 for storing the identifier of the entry of the chunk management table 38 corresponding to the relevant logical chunk.

The PChunkSet 393 stores the identifier of one or more physical chunks allocated to the relevant logical chunk.

FIG. 8 shows an example of the physical chunk management table 40. The physical chunk management table 40 includes, in one entry, an Id 401 for storing the identifier of a physical chunk, a deviceId 402 for storing the identifier of the storage device 23, and an address 403 indicating a location in the storage device 23.

<Volume Generation Processing>

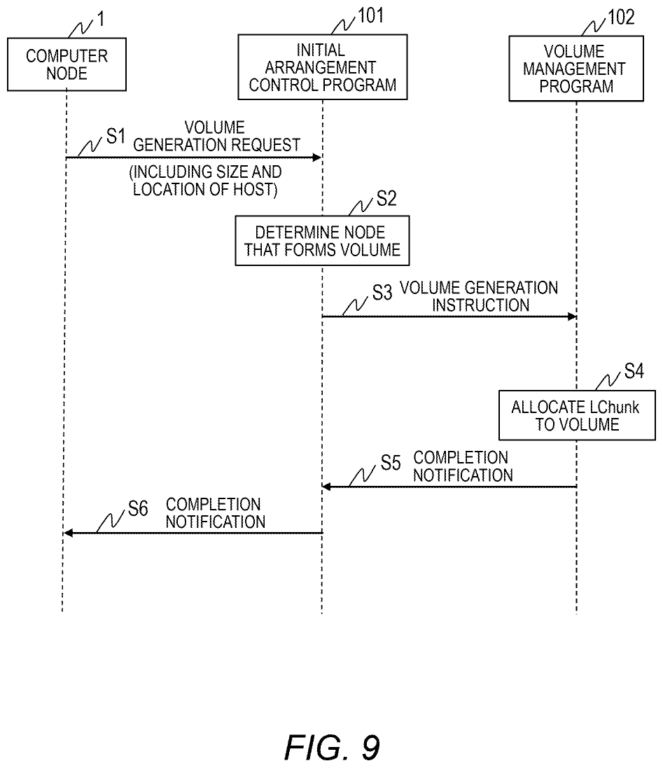

FIG. 9 is a sequence diagram for illustrating an example of processing for generating a volume, which is performed by the storage node 2. This processing is executed based on a request received from the computer node 1 or the controller node 3.

The computer node 1 notifies the storage node 2 of a volume generation request including the size of a volume and location information on the computer node 1 (Step S1). The location information on the computer node 1 is formed of, for example, the identifier of a computer port. The description of the first embodiment is directed to an example in which a logical chunk and a physical chunk are set in advance in the storage node 2.

When the logical chunk and the physical chunk are not set in advance, the size of a chunk can be included in the volume generation request.

In the storage node 2, the initial arrangement control program 101 receives a volume generation request. The initial arrangement control program 101 determines the storage node 2 including the minimum physical distance from the computer node 1 being a request source based on the location information included in the volume generation request (Step S2).

The physical distance between the computer node 1 and the storage node 2 may be determined by referring to a table set in advance. In another case, the initial arrangement control program 101 may use, for example, latency instead of the physical distance.

The initial arrangement control program 101 instructs the determined storage node 2 to generate a volume (Step S3). In the storage node 2 that has been instructed to generate a volume, the volume management program 102 generates a volume to which a logical chunk that satisfies the size of the volume generation request is allocated (Step S4).

The volume management program 102 allocates a logical chunk in the same storage node 2 (that is, a local logical chunk) to a new volume. After adding the entry including a new Id 371 with the L chunk set 375 to the volume management table 37, the volume management program 102 notifies the initial arrangement control program 101 of the completion of generation of the volume (Step S5).

Information including the id 371 of the volume and the L chunk set 375 can be included in the notification of the completion of generation of the volume. In this case, the initial arrangement control program 101 of the storage node 2 that has received the notification of the completion of generation adds the id 371 of the volume and the content of the L chunk set 375 to its own volume management table 37.

Subsequently, the initial arrangement control program 101 transmits the notification of the completion of generation of the volume to the computer node 1 that has requested the generation of the volume (Step S6). This notification of the completion of generation includes the identifier (nodeId 392) of the storage node 2 and the identifier (Id 371) of the volume.

With the above-mentioned processing, when the computer node 1 requests the generation of a volume, the storage node 2 generates a volume in the storage node 2 including the minimum physical distance from the computer node 1. This allows the computer node 1 to access the storage node 2 at high speed, and to perform the processing of the distributed processing system 120 at high speed.

<Write Processing and Redundancy Processing>

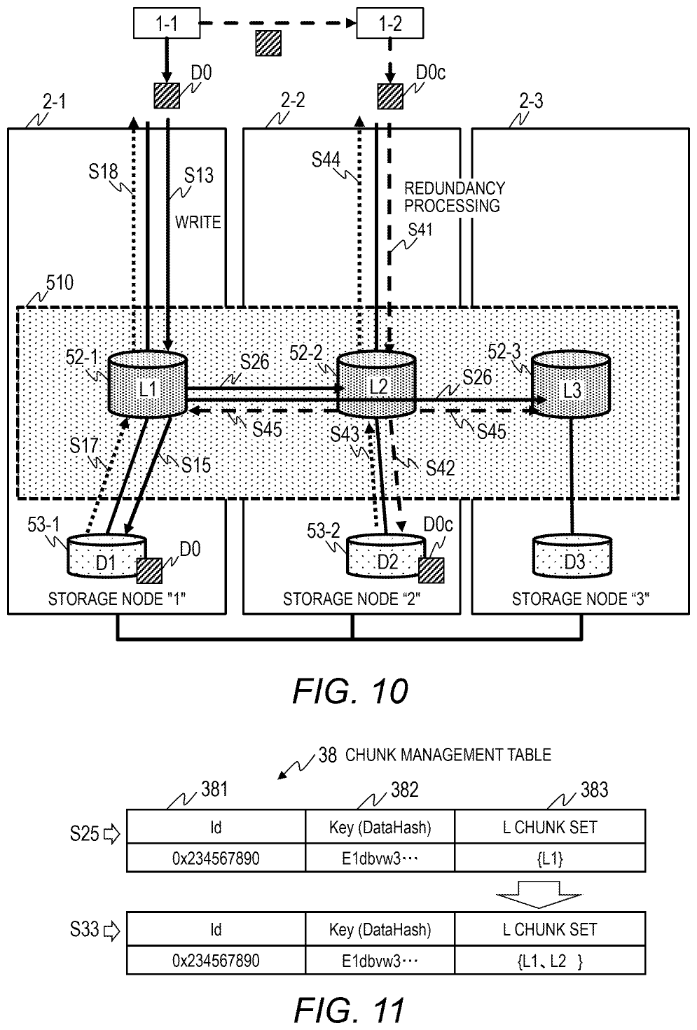

FIG. 10 is a diagram for illustrating an example of write processing and redundancy processing, which are performed in the storage nodes. In the example of the processing, as illustrated in FIG. 3, the computer node 1-1 transmits, to the storage node 2-1, a request to write the data D0 to a predetermined volume, and the distributed processing system 120 including a redundancy function transmits the replica (data D0c) of the data D0 in the computer node 1-1 to the computer node 1-2. Then, the computer node 1-2 stores the data D0c being the replica in the storage node 2-2.

When receiving the write request for the data D0 from the computer node 1-1, the storage node 2-1 writes the data D0 to the logical chunk 52-1 of the designated volume (Step S13). The data D0 written to the logical chunk 52-1 is also written to the physical chunk 53-1 allocated to the logical chunk 52-1 (Step S15).

The storage node 2-1 transmits a notification of the completion of writing to the computer node 1-1 based on a notification of the completion of writing to the physical chunk 53-1 (Step S17) and a notification of the completion of writing to the logical chunk 52-1 (Step S18).

The data D0c being the replica transmitted to the computer node 1-2 by the distributed processing system 120 including a redundancy function is written to a predetermined volume of the storage node 2-1.

When receiving the write request for the data D0c from the computer node 1-2, the storage node 2-2 writes the data D0c to the logical chunk 52-2 of the designated volume (Step S41). The data D0c written to the logical chunk 52-2 is also written to the physical chunk 53-2 allocated to the logical chunk 52-2 (Step S42).

The storage node 2-2 transmits a notification of the completion of writing to the computer node 1-2 based on a notification of the completion of writing to the physical chunk 53-2 (Step S43) and a notification of the completion of writing to the logical chunk 52-2 (Step S44).

With the above-mentioned processing, the redundancy processing performed by the distributed processing system 120 of the computer node 1 is completed. Next, a description is given of the redundancy processing to be performed by the distributed storage system.

The storage node 2-1 calculates the hash value of the newly written data D0 at a predetermined timing, and adds the hash value to the chunk management table 38 in association with the identifier of the logical chunk 52-1 (Step S25). FIG. 11 is an example of the chunk management table 38 obtained by the redundancy processing. In the example shown in FIG. 11, the hash value for the logical chunk “L1” (52-1) is added to the chunk management table 38. The hash value is calculated in the same manner in the other storage nodes 2-2 and 2-3 as well.

The storage node 2-1 queries the other storage nodes 2-2 and 2-3 about a logical chunk including the same hash value as the calculated hash value (Step S26). The storage node 2-2, in which the hash value of the data D0c matches the calculated hash value, transmits the logical chunk “L2” (52-2) to the storage node 2-1 (Step S45).

The storage node 2-1 can determine that the data D0 in the logical chunk “L1” of the own node and the data D0c in the logical chunk “L2” of the storage node 2-2 form a copy pair.

When the hash values match each other, the storage node 2-1 requests the data D0c in the logical chunk “L2” in order to prevent a collision between the hash values, and determines that the hash values do not collide. Then, the storage node 2-1 adds the hash value and the logical chunks “L1” and “L2” to the chunk management table 38 as a copy pair (Step S33).

FIG. 11 shows an example of the chunk management table 38 obtained by the redundancy processing. In the example shown in FIG. 11, the logical chunks “L1” and “L2” are added to the chunk management table 38 as a copy pair including the same hash value.

As described above, after redundancy is achieved in the distributed processing system 120 including a redundancy function, the storage node 2 searches for a logical chunk including the same hash value, and when there is a logical chunk including the same data, performs the redundancy processing for registering the logical chunk as one that forms a copy pair in the chunk management table 38. In this manner, the storage nodes 2 utilize the redundancy function of the distributed processing system 120, without achieving redundancy by themselves, to construct a redundant configuration asynchronously.

<Details of Processing>

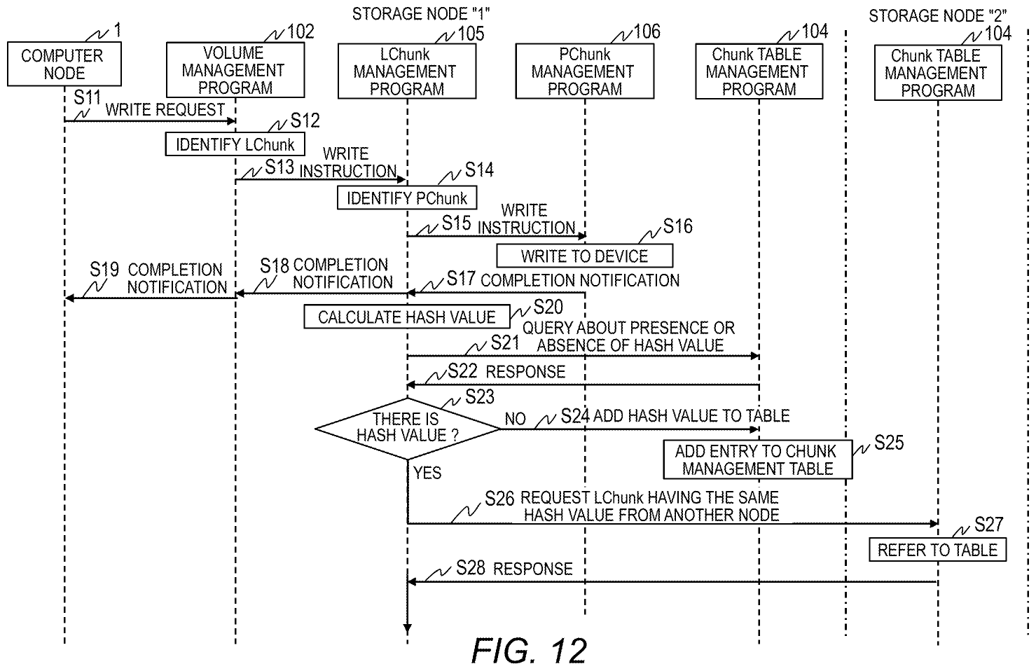

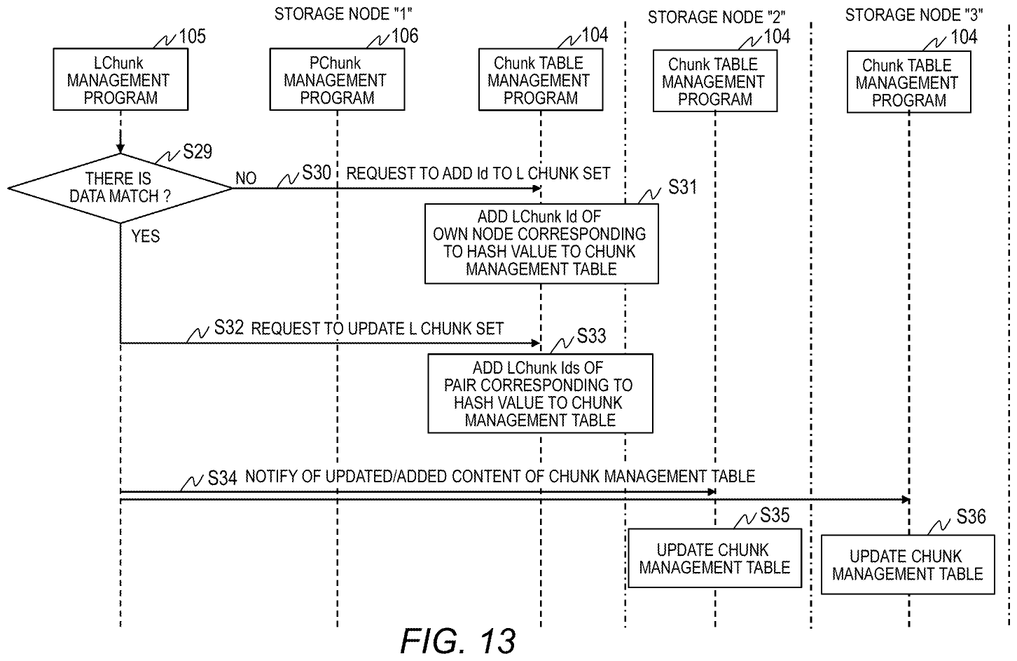

FIG. 12 and FIG. 13 are sequence diagrams for illustrating detailed processing of the write processing and redundancy processing, which are performed in the storage nodes. The computer node 1 transmits a write request to the storage node 2-1 by designating the address (or Id) of a volume and data in the write request (Step S11).

In the storage node 2-1, the volume management program 102 receives the write request, and identifies the identifier of the logical chunk corresponding to the address (Id) from the L chunk set 375 of the volume management table 37 (Step S12).

The volume management program 102 instructs the logical chunk management program 105 to write data by designating the identifier of the logical chunk (Step S13).

The logical chunk management program 105 refers to the logical chunk management table 39 to identify the identifier of the physical chunk from the PChunkSet 393 in the entry of the Id 391 corresponding to the identifier of the logical chunk (Step S14).

The logical chunk management program 105 instructs the physical chunk management program 106 to write data to the identified identifier of the physical chunk (Step S15). The physical chunk management program 106 writes the data to the physical chunk of the designated storage device 23 (Step S16). When the writing is completed, the physical chunk management program 106 notifies the logical chunk management program 105 of the completion of writing (Step S17).

The logical chunk management program 105 transmits a notification of the completion of writing to the volume management program 102 (Step S18), and the volume management program 102 transmits a notification of the completion of writing to the computer node 1 (Step S19).

Subsequently, when a predetermined timing is reached asynchronously with the above-mentioned write processing, the logical chunk management program 105 calculates the hash value of the data that has been written (Step S20). The logical chunk management program 105 queries the chunk table management program 104 whether or not the chunk management table 38 has an entry with the hash value matching the above-mentioned calculated hash value (Step S21).

The chunk table management program 104 refers to the chunk management table 38 to return, to the logical chunk management program 105, a response indicating whether or not there is a hash value (Step S22). The logical chunk management program 105 determines whether or not there is a hash value (Step S23), and when there is no hash value in the chunk management table 38, instructs the chunk table management program 104 to add a new entry (Step S24).

The chunk table management program 104 adds a new entry to the chunk management table 38, assigns the Id 381 to the new entry, and stores the hash value in the Key (DataHash) 382 (Step S25). The Id 381 is the identifier of an entry of the chunk management table 38, and a value unique in the distributed storage system is assigned to the entry. The Id 381 also functions as the identifier of a copy pair, and is stored in the ChunkTableId 394 of the logical chunk management table 39.

Meanwhile, when there is a hash value in the chunk management table 38, the logical chunk management program 105 queries another storage node 2 whether or not there is a logical chunk including the same hash value (Step S26).

In the other storage node 2-2, the chunk table management program 104 receives a hash value, and determines whether the same hash value is present in the chunk management table 38 of the own node (Step S27). When the same hash value is present, the chunk table management program 104 reads the data and the identifier from the logical chunk of the L chunk set 383, and returns a response to the storage node 2-1 (Step S28).

In Step S29 of FIG. 13, the logical chunk management program 105 determines whether or not the data included in the response matches the data in the logical chunk of the own node corresponding to the hash value. When the data included in the response and the data in the own node do not match, a collision has occurred between the hash values, and hence the logical chunk management program 105 instructs the chunk table management program 104 to add the relevant hash value and the relevant logical chunk to the chunk management table 38 by assigning a new Id 381 (Step S30).

When a collision occurs between the hash values, an entry including a different Id 381 and the same Key (DataHash) 382 is added to the chunk management table 38, and the duplicate pieces of data including the same Key (DataHash) 382 can be managed separately from each other.

The chunk table management program 104 adds a new entry to the chunk management table 38 by assigning a new Id 381 to the relevant hash value and the relevant logical chunk in response to the above-mentioned instruction (Step S31).

Meanwhile, when determining in Step S29 that the data included in the response matches the data in the own node, the logical chunk management program 105 can determine that the logical chunk of the other node is one that forms a copy pair. The logical chunk management program 105 instructs the chunk table management program 104 to add the identifier of the logical chunk of the other node to the L chunk set 383 including the relevant hash value (Step S32).

The chunk table management program 104 forms a copy pair by adding the identifier of the logical chunk of the other node to the L chunk set 383 in the entry including the relevant hash value (Step S33).

The logical chunk management program 105 has completed the update of or addition to the chunk management table 38, and hence the logical chunk management program 105 notifies each of the other storage nodes 2 of the changed content of the chunk management table 38, and brings the processing to an end.

With the above-mentioned processing, after redundancy is achieved in the distributed processing system 120 including a redundancy function, the logical chunk management program 105 of the storage node 2 searches for a logical chunk including the same hash value, and when there is a logical chunk including the same data, registers the logical chunk in the chunk management table 38 as one that forms a copy pair. This allows the logical chunk management program 105 to perform the redundancy processing on the storage node 2 side.

The redundancy processing in Step S20 and the subsequent steps can be performed asynchronously with the write processing, and may therefore be performed at a predetermined timing suitable for, for example, a load on the storage node 2.

<Update Processing>

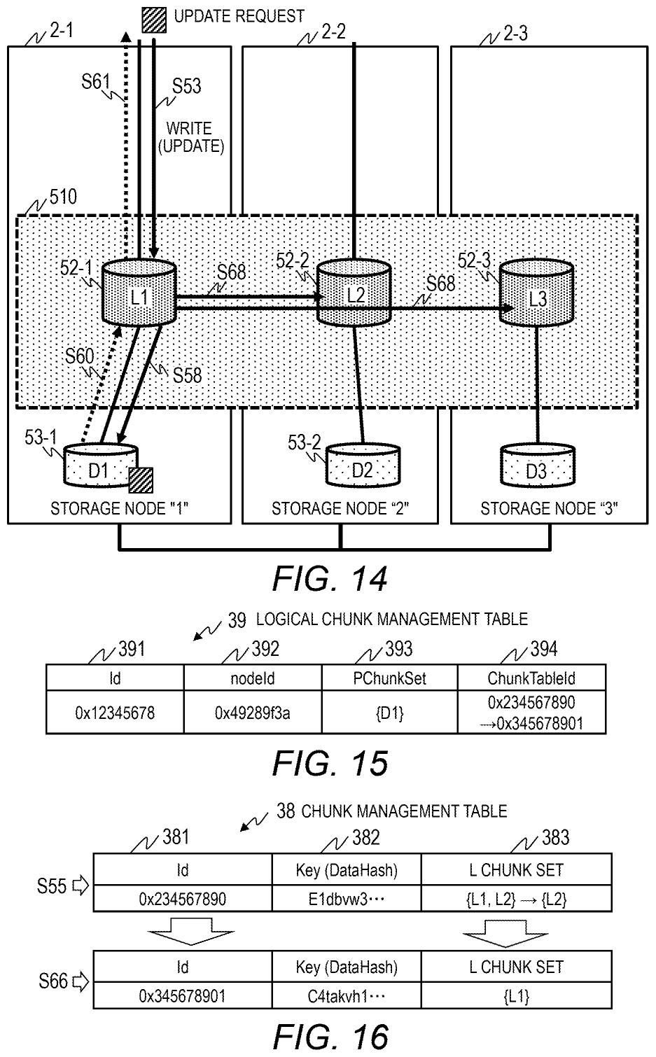

FIG. 14 is a diagram for illustrating an example of update processing to be performed in the storage nodes 2. When receiving the write (update) request for the data from the computer node 1-1, the storage node 2-1 writes the data to the logical chunk 52-1 of the designated volume (Step S53). The data D0 written to the logical chunk 52-1 is also written to the physical chunk 53-1 allocated to the logical chunk 52-1 (Step S58).

In the case of the update, a change is made to the data in the logical chunk, and hence, as shown in FIG. 16, the storage node 2 deletes, from the L chunk set 383 of the chunk management table 38, the identifier of the logical chunk involved before the update (see “L1” in FIG. 16). In other words, the storage node 2 temporarily cancels the pair of logical chunks to be subjected to the update.

Then, the storage node 2 calculates the hash value of the data in the logical chunk involved after the update, and then adds a new entry to the chunk management table 38 (Step S66). A new Id 381 is assigned to the chunk management table 38, and the identifier of the logical chunk to be subjected to the update is stored in the L chunk set 383. In addition, the hash value of the updated data is stored in the Key (DataHash) 382.

The entry of the logical chunk to be subjected to the update has been changed in the chunk management table 38, and hence, as shown in FIG. 15, the storage node 2 updates the ChunkTableId 394 of the logical chunk management table 39 to the Id 381 of the chunk management table 38 obtained after the update.

The storage node 2-1 transmits a notification of the completion of update to the computer node 1-1 based on a notification of the completion of update to the physical chunk 53-1 (Step S60) and a notification of the completion of update to the logical chunk 52-1 (Step S61).

The storage node 2-1 synchronizes the chunk management tables 38 by notifying the other storage nodes 2-2 and 2-3 of the updated content of the chunk management table 38 asynchronously with the above-mentioned update processing.

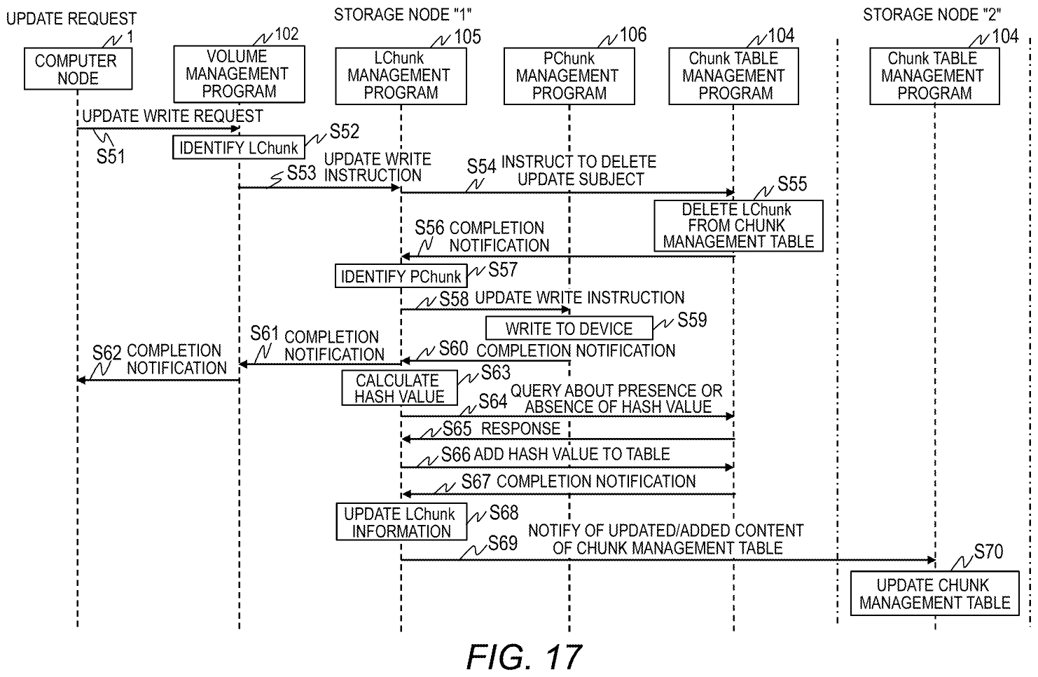

FIG. 17 is a sequence diagram for illustrating an example of update processing to be performed in the storage nodes.

The computer node 1 transmits an update request to the storage node 2-1 by designating the address (or Id) of a volume and data therein (Step S51).

In the storage node 2-1, the volume management program 102 receives the update request, and identifies the identifier of the logical chunk corresponding to the address (Id) from the L chunk set 375 of the volume management table 37 (Step S52).

The volume management program 102 instructs the logical chunk management program 105 to update data by designating the identifier of the logical chunk (Step S53).

The logical chunk management program 105 instructs the chunk table management program 104 to delete the identifier of the logical chunk to be subjected to the update (Step S54). The chunk table management program 104 identifies the entry of the logical chunk to be subjected to the update from the chunk management table 38, deletes the identifier of the logical chunk from the L chunk set 383 (Step S55), and returns a notification of the completion to the logical chunk management program 105 (Step S56).

The logical chunk management program 105 refers to the logical chunk management table 39 to identify the identifier of the physical chunk from the PChunkSet 393 in the entry of the Id 391 corresponding to the identifier of the logical chunk (Step S57).

The logical chunk management program 105 instructs the physical chunk management program 106 to write data and the identified identifier of the physical chunk (Step S58). The physical chunk management program 106 writes the data to the physical chunk of the designated storage device 23 (Step S59). When the writing is completed, the physical chunk management program 106 notifies the logical chunk management program 105 of the completion of writing (Step S60).

The logical chunk management program 105 transmits a notification of the completion of writing to the volume management program 102 (Step S61), and the volume management program 102 transmits a notification of the completion of update to the computer node 1 (Step S62).

Subsequently, when a predetermined timing is reached asynchronously with the above-mentioned update processing, the logical chunk management program 105 calculates the hash value of the data that has been updated (Step S63). The logical chunk management program 105 queries the chunk table management program 104 whether or not the chunk management table 38 has an entry with the hash value matching the above-mentioned calculated hash value (Step S64).

When receiving the response from the chunk table management program 104 (Step S65), the logical chunk management program 105 instructs the chunk table management program 104 to add the updated hash value to a new entry as shown in FIG. 16 (Step S66). The chunk table management program 104 adds the entry of a new Id 381 to store the hash value and the identifier of the logical chunk, and returns the new Id 381 (Step S67).

When receiving the new Id 381, the logical chunk management program 105 updates the ChunkTableId 394 with the new Id 381 in the entry to be subjected to the update in the logical chunk management table 39 as shown in FIG. 15 (Step S68).

The logical chunk management program 105 notifies the other storage nodes 2-2 and 2-3 of the content of the change of (update of and addition to) the chunk management table 38, and brings the update processing to an end (Step S69).

In the case of the update processing, in the L chunk set 383 of the chunk management table 38, the pairing is temporarily released, and when there is a subsequent write, the redundancy processing in Step S20 and the subsequent steps of FIG. 12 is performed again, to thereby perform the pairing of the identifiers of the logical chunks that form a copy pair.

<Read Processing>

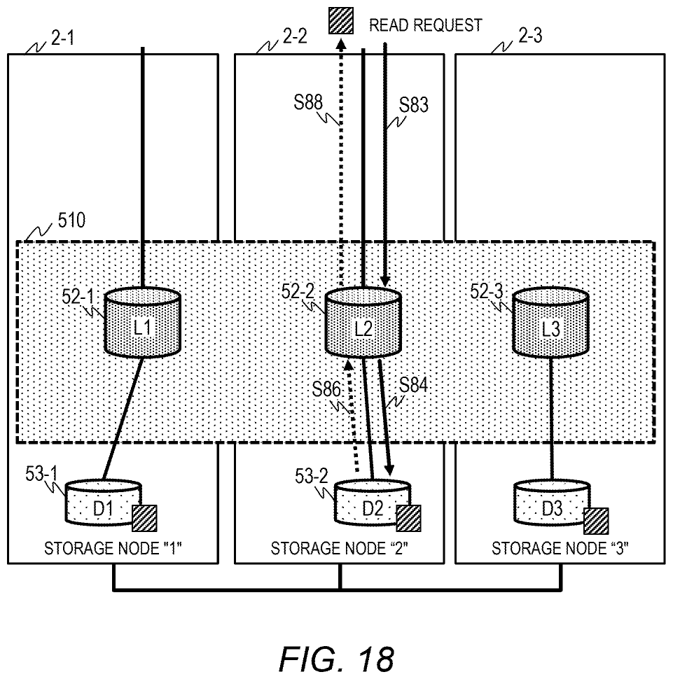

FIG. 18 is a diagram for illustrating an example of read processing to be performed by the storage node 2-2. When receiving a read request for data from the computer node 1-2, the storage node 2-2 requests the data from the logical chunk 52-2 of the designated volume (Step S83). The storage node 2-2 reads the data from the physical chunk 53-2 allocated to the logical chunk 52-2 (Step S84).

The storage node 2-2 transmits the data read from the physical chunk 53-2 to the computer node 1-2 through the logical chunk 52-2 (Step S86 and Step S88).

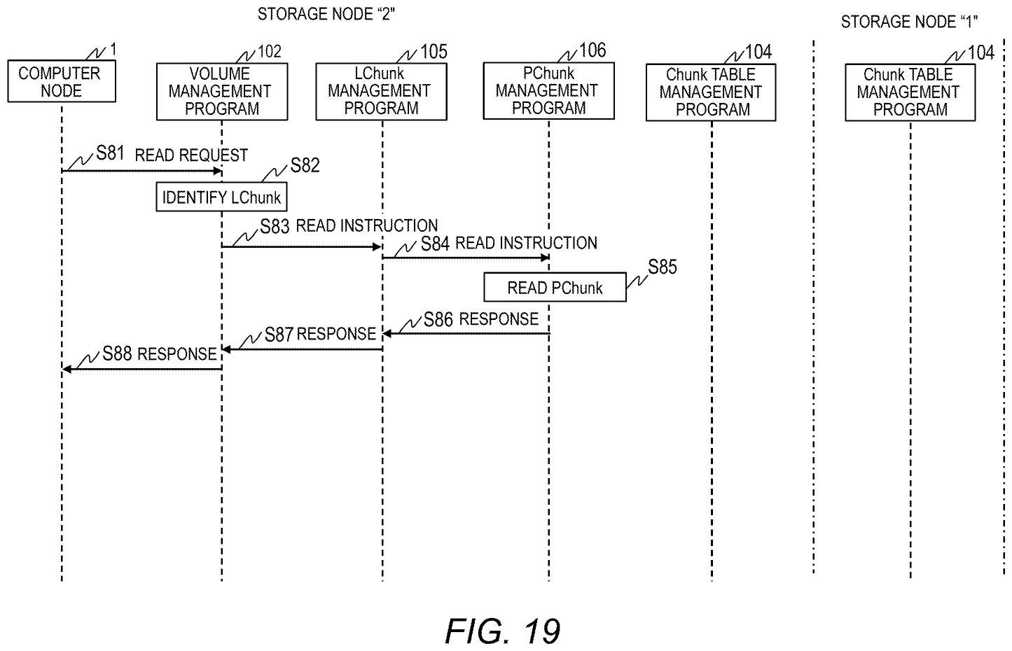

FIG. 19 is a sequence diagram for illustrating an example of read processing to be performed in the storage nodes 2-2. The computer node 1 transmits a read request to the storage node 2-2 by designating the address (or Id) of a volume (Step S81).

In the storage node 2-2, the volume management program 102 receives the read request, and identifies the identifier of the logical chunk corresponding to the address (Id) from the L chunk set 375 of the volume management table 37 (Step S82).

The volume management program 102 instructs the logical chunk management program 105 to read data by designating the identifier of the logical chunk (Step S83).

The logical chunk management program 105 refers to the logical chunk management table 39 to identify the identifier of the physical chunk from the PChunkSet 393 in the entry of the Id 391 corresponding to the identifier of the logical chunk, and instructs the physical chunk management program 106 to read data from the relevant identifier of the physical chunk (Step S84).

The physical chunk management program 106 reads data from the physical chunk of the designated storage device 23 (Step S85). When the reading is completed, the physical chunk management program 106 transmits the data to the logical chunk management program 105 (Step S86).

The logical chunk management program 105 returns the read data to the volume management program 102 (Step S87), and the volume management program 102 returns the read data to the computer node 1 (Step S88).

With the above-mentioned processing, the computer node 1-2 can acquire data from the local storage device 23 of the storage node 2-2, to thereby be able to promote an increase in processing speed.

<Read Processing at Failure Occurrence>

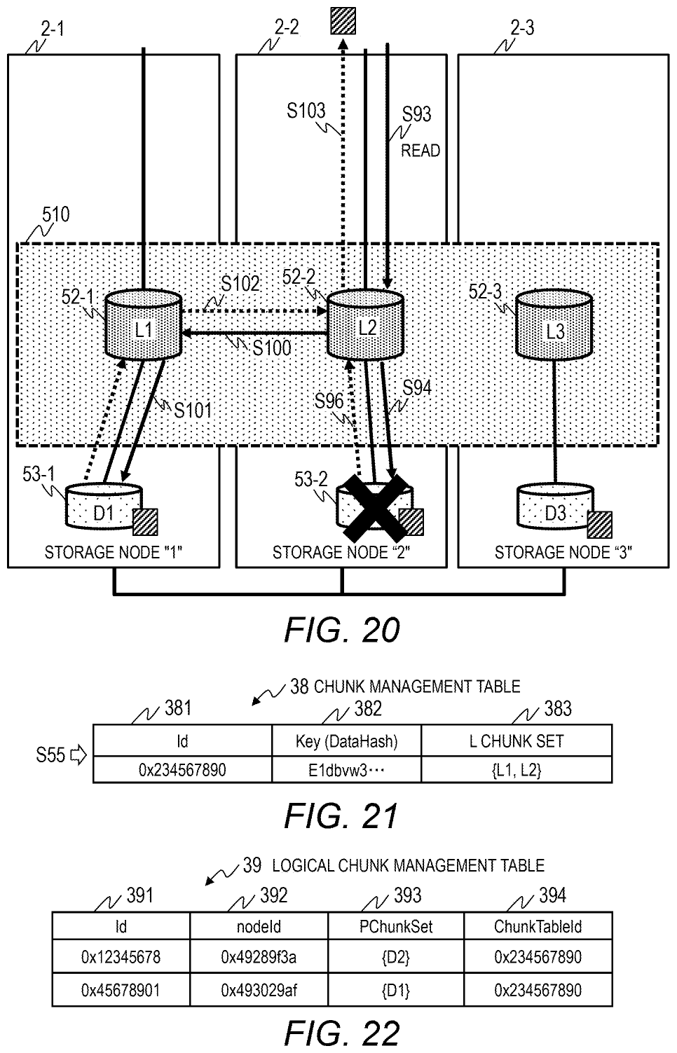

FIG. 20 is a diagram for illustrating an example of the read processing at a failure occurrence, which is performed by the storage node 2-2 when a failure occurs. When receiving a read request for data from the computer node 1-2, the storage node 2-2 requests the data from the logical chunk 52-2 of the designated volume (Step S93).

The storage node 2-2 reads the data from the physical chunk 53-2 allocated to the logical chunk 52-2 (Step S94). However, due to the occurrence of a failure in the physical chunk 53-2, an error or a timeout occurs (Step S96).

The storage node 2-2 refers to the chunk management table 38 to acquire an identifier other than the identifier of the logical chunk 52-2 as the identifier of the logical chunk that forms the copy pair from the entry including the identifier of the logical chunk 52-2 in the L chunk set 383.

The storage node 2-2 refers to the logical chunk management table 39 to acquire the nodeId 392 from the entry of the identifier of the copy pair, to thereby identify the storage node 2-1 storing the data that forms the copy pair.

The storage node 2-2 requests the data of the identifier of the logical chunk (52-1) that forms the copy pair from the storage node 2-1 storing the data that forms the copy pair (Step S100). The storage node 2-1 reads the data from the physical chunk 53-1 allocated to the logical chunk 52-1 (Step S101).

For example, in the chunk management table 38 of FIG. 21, a failure has occurred in the logical chunk of the identifier “L2” included in the L chunk set 383, and hence the storage node 2-2 acquires the identifier “L1” of the logical chunk. The storage node 2-2 acquires the nodeId 392 “0x493029af” from the entry of “0x45678901” corresponding to “L1” in the logical chunk management table 39 shown in FIG. 22, and requests data in the logical chunk of the identifier “L1” from the storage node 2-1 of the acquired identifier.

The storage node 2-1 transmits the data that forms the copy pair read from the physical chunk 53-1 to the storage node 2-2 (Step S102). The storage node 2-2 returns the data that forms the copy pair received from the storage node 2-1 to the computer node 1-2.

With the above-mentioned processing, when a failure occurs in, for example, the storage device 23, the storage node 2 acquires the identifier of the logical chunk of another storage node 2 from the L chunk set 383 of the chunk management table 38, and reads data that forms a copy pair. This allows the storage node 2 to achieve normal read processing even when a failure occurs.

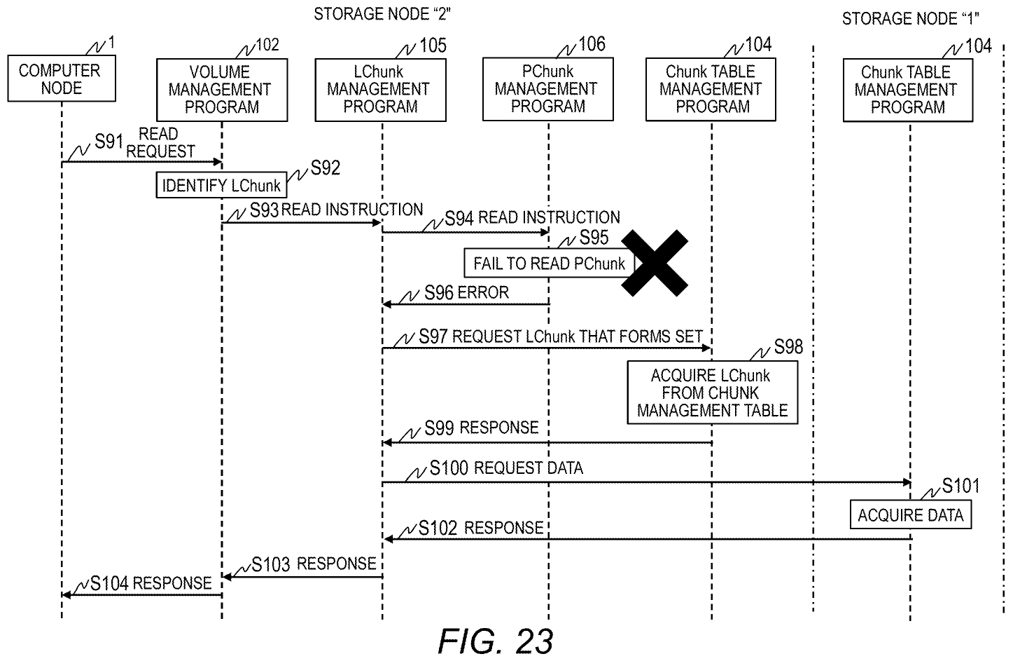

FIG. 23 is a sequence diagram for illustrating an example of the read processing to be performed in the storage nodes when a failure occurs. The computer node 1 transmits a read request to the storage node 2-2 by designating the address (or Id) of the volume (Step S91).

In the storage node 2-2, the volume management program 102 receives the read request, and identifies the identifier of the logical chunk corresponding to the address (Id) from the L chunk set 375 of the volume management table 37 (Step S92).

The volume management program 102 instructs the logical chunk management program 105 to read data by designating the identifier of the logical chunk (Step S93).

The logical chunk management program 105 refers to the logical chunk management table 39 to identify the identifier of the physical chunk from the PChunkSet 393 in the entry of the Id 391 corresponding to the identifier of the logical chunk, and instructs the physical chunk management program 106 to read data from the relevant identifier of the physical chunk (Step S94).

The physical chunk management program 106 fails to read the designated physical chunk due to a failure in the storage device 23 or another such reason (Step S95). The physical chunk management program 106 detects an error or a timeout from the storage device 23 (Step S96).

The logical chunk management program 105 requests a copy pair of the identifiers of the logical chunks from the chunk table management program 104 (Step S97). The chunk table management program 104 searches for an entry including the identifier of the logical chunk involved in the read failure in the L chunk set 383, and acquires the identifiers of the logical chunks that form a copy pair from the L chunk set 383 (Step S98).

The chunk table management program 104 returns the identifiers of the logical chunks that form a copy pair to the logical chunk management program 105 (Step S99). The logical chunk management program 105 refers to the logical chunk management table 39 to acquire the nodeId 392 from the entry of the identifier of the copy pair, to thereby identify the storage node 2-1 storing the data that forms the copy pair.

The logical chunk management program 105 requests the data of the identifier of the logical chunk that forms the copy pair from the storage node 2-1 storing the data that forms the copy pair (Step S100). In the storage node 2-1, the logical chunk management program 105 receives the identifier of the logical chunk, and reads the data from the physical chunk 53-1 allocated to the relevant logical chunk (Step S101). The logical chunk management program 105 returns the data to the logical chunk management program 105 of the storage node 2-2 (Step S102).

The logical chunk management program 105 of the storage node 2-2 returns the data that forms the copy pair acquired from the storage node 2-1 to the volume management program 102 (Step S103). The volume management program 102 returns the data that forms the copy pair to the computer node 1.

As described above, the storage node 2 does not have redundancy at first when data is written, but detects and manages a copy pair corresponding to the redundancy level of the distributed processing system 120 in the layer of the logical chunk 52 (in the data protection layer 510), to thereby ensure redundancy without achieving redundancy on the distributed storage system side. This allows the storage node 2 to prevent the redundancy level from becoming excessive even when the storage node 2 is combined with the distributed processing system 120. In addition, the storage node 2 always writes data to the local volume 51 (physical chunk 53) in response to a write request received from the computer node 1 to which the relevant storage node 2 is allocated, to thereby be able to achieve an increase in processing speed of the distributed processing system 120.

### [Second Embodiment]

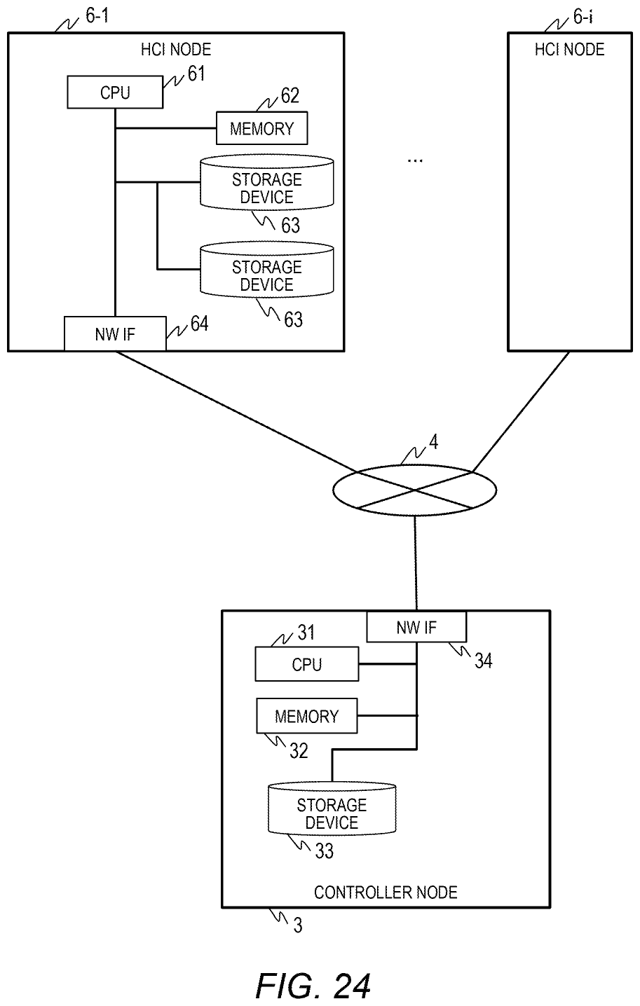

FIG. 24 is a block diagram for illustrating an example of a distributed storage system according to a second embodiment of this invention. The description of the second embodiment is directed to an example in which the distributed processing system 120 and the distributed storage system are formed of hyper-converged infrastructure (HCI) nodes 6-1 to 6-i each integrating a computer and a storage, instead of the computer nodes 1 and the storage nodes 2 in the first embodiment. The other configurations are the same as those in the first embodiment.

The HCI node 6-1 is a computer including a CPU 61, a memory 62, a storage device 63, and a network interface 64. A distributed processing program including a redundancy function and various programs that form the distributed storage system are loaded into the memory 62 to be executed by the CPU 61. The network interface 64 is coupled to the network 4 to communicate to/from another HCI node 6.

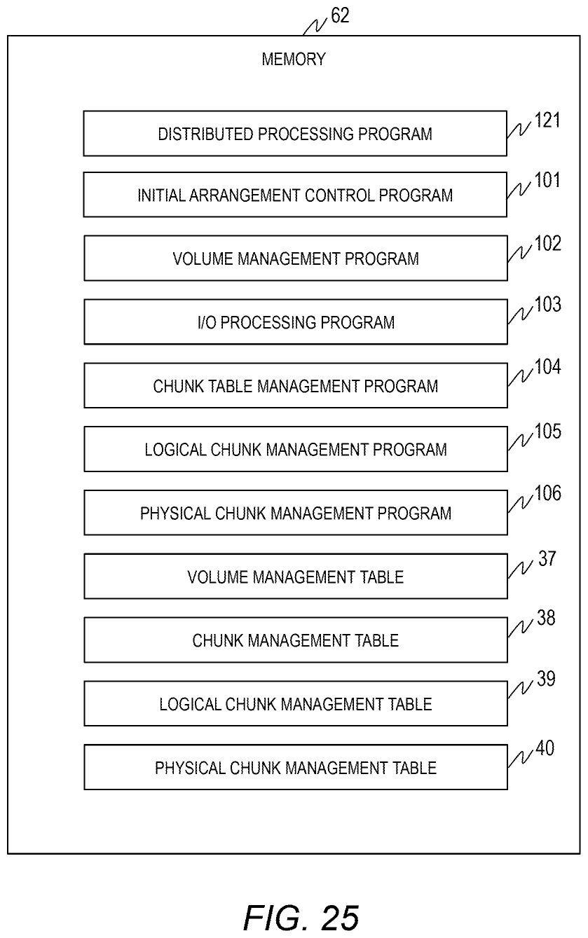

FIG. 25 is a block diagram for illustrating an example of the software configuration of the HCI node 6. In the memory 62 of the HCI node 6, a distributed processing program 121 that forms the distributed processing system 120 including a redundancy function is stored in addition to the programs and tables that form the distributed storage system described in the first embodiment.

The programs stored in the distributed storage system include the initial arrangement control program 101, the volume management program 102, the I/O processing program 103, the chunk table management program 104, the logical chunk management program 105, and the physical chunk management program 106. The tables include the volume management table 37, the chunk management table 38, the logical chunk management table 39, and the physical chunk management table 40.

In the second embodiment as well, the distributed storage system side does not have redundancy at first when data is written, but detects and manages a copy pair corresponding to the redundancy level of the distributed processing system 120 in the layer of the logical chunk (in the data protection layer 510), to thereby ensure redundancy without achieving redundancy on the distributed storage system side. This allows the distributed storage system to prevent the redundancy level from becoming excessive even when the distributed storage system is combined with the distributed processing system 120. In addition, the HCI node 6 always writes data to the local volume (physical chunk) in response to a write request received from the HCI node 6 to which the relevant volume is allocated, to thereby be able to achieve an increase in processing speed of the distributed processing system 120.

<Conclusion>

As described above, the distributed storage systems according to the first embodiment and the second embodiment described above can be configured as follows.

(1) There is provided a distributed storage system, which includes a plurality of nodes (storage nodes 2) coupled to each other, the plurality of nodes each including a processor (21), a memory (22), a storage device (storage device 23), and a network interface (24), the distributed storage system including: a physical chunk management module (physical chunk management program 106) configured to manage physical chunks (53) obtained by dividing a physical storage area of the storage device (23) by a predetermined size; a logical chunk management module (logical chunk management program 105) configured to manage, as each of logical chunks (52), a logical storage area to which one or more physical chunks (53) among the physical chunks (53) is allocated; a volume management module (volume management program 102) configured to provide a volume (51) to which one or more logical chunks (52) among the logical chunks (52) is allocated, to outside; and a pair management module (chunk table management program 104) configured to manage, as a pair, the logical chunks (52) storing the same data among the plurality of nodes (2), the volume management module (102) being configured to identify, when a write request for the data is received, one of the logical chunks (52) that forms a designated volume (51), and transmit, to the logical chunk management module (105), an instruction to write the data to the identified one of the logical chunks (52), the logical chunk management module (105) being configured to identify one of the physical chunks (53) that forms the one of the logical chunks (52), and transmit, to the logical chunk management module (105), an instruction to write the data to the one of the physical chunks (53), the logical chunk management module (105) being configured to write the data to the identified one of the physical chunks (53), the pair management module (104) being configured to calculate a hash value of the data, transmit the hash value to another node (2), and issue a query about presence or absence of the same hash value.

With the above-mentioned configuration, the storage node 2 does not have redundancy at first when data is written by the distributed processing system 120 including a redundancy function. However, the chunk table management program (pair management module) 104 queries another storage node 2 about presence or absence of the hash value in the chunk management table 38 (pair management information), to thereby be able to detect a copy pair written by the distributed processing system 120. This can prevent the redundancy level from becoming excessive even when the storage node 2 is combined with the distributed processing system 120.

(2) In the distributed storage system according to the above-mentioned item (1), the pair management module (104) is configured to acquire, when the same hash value is present as a result of the query, an identifier of one of the logical chunks (52) including the same hash value from the another node (2) as a second identifier, set an identifier of one of the logical chunks (52) in an own node (2) as a first identifier, and set the first identifier and the second identifier as a pair in pair management information (chunk management table 38).

With the above-mentioned configuration, the storage node 2 does not have redundancy at first when data is written. However, a copy pair corresponding to the redundancy level of the distributed processing system 120 is detected and managed in the layer of the logical chunk 52 (in the data protection layer 510), to thereby ensure redundancy without achieving redundancy on the distributed storage system side. This can prevent the redundancy level from becoming excessive even when the storage node 2 is combined with the distributed processing system 120.

(3) In the distributed storage system according to the above-mentioned item (2), the pair management module (104) is configured to acquire, when the same hash value is present as a result of the query, data including the same hash value in the another node (2), compare the data in the another node (2) with the data in the own node, and when the data in the another node (2) with the data in the own node do not match each other, set the one of the logical chunks (52) including the data in the own node and the one of the logical chunks (52) including the data in the another node (2) as different logical chunks (52) in the pair management information (38) without forming a pair therebetween.

With the above-mentioned configuration, when the hash value in the chunk management table 38 causes a collision, an entry including a different Id 381 and the same Key (DataHash) 382 is added to the chunk management table 38, and the duplicate pieces of data including the same Key (DataHash) 382 can be managed separately from each other.

(4) In the distributed storage system according to the above-mentioned item (1), the logical chunk management module (105) is configured to allocate one of the physical chunks (53) within the same node (2) to each of the logical chunks (52).

With the above-mentioned configuration, the storage node 2 always writes data to the local volume 51 (physical chunk 53) in response to a write request received from the computer node 1 to which the relevant storage node 2 is allocated, to thereby be able to achieve an increase in processing speed of the distributed processing system 120.

(5) In the distributed storage system according to the above-mentioned item (2), the pair management module (104) is configured to delete, when the write request for the data is a request to update the data, the first identifier from the pair management information (38) to cancel the pair.

With the above-mentioned configuration, when writing relates to an update, the pair of the L chunk set 383 of the chunk management table 38 (pair management information) is temporarily canceled, and a new entry is added to the chunk management table 38 to store the hash value of data obtained after the update. When the redundancy processing is performed later, a copy pair can be formed again between the above-mentioned data and update data written to another storage node 2 by the redundancy function of the distributed processing system 120.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A distributed storage system, which includes a plurality of nodes coupled to each other, the plurality of nodes each including a processor, a memory, a storage device, and a network interface,
the distributed storage system comprising:
a physical chunk management module configured to manage physical chunks obtained by dividing a physical storage area of the storage device by a predetermined size;
a logical chunk management module configured to manage, as each of logical chunks, a logical storage area to which one or more physical chunks among the physical chunks is allocated;
a volume management module configured to provide a volume to which one or more logical chunks among the logical chunks is allocated, to outside; and
a pair management module configured to manage, as a pair, the logical chunks storing the same data among the plurality of nodes,
the volume management module being configured to identify, when a write request for the data is received, one of the logical chunks that forms a designated volume, and transmit, to the logical chunk management module, an instruction to write the data to the identified one of the logical chunks,
the logical chunk management module being configured to identify one of the physical chunks that forms the one of the logical chunks, and transmit, to the physical chunk management module, an instruction to write the data to the one of the physical chunks,
the physical chunk management module being configured to write the data to the identified one of the physical chunks,
the pair management module being configured to calculate a hash value of the data, transmit the hash value to another node, and issue a query about presence or absence of the same hash value.

2. The distributed storage system according to claim 1, wherein the pair management module is configured to acquire, when the same hash value is present as a result of the query, an identifier of one of the logical chunks including the same hash value from the another node as a second identifier, set an identifier of one of the logical chunks in an own node as a first identifier, and set the first identifier and the second identifier as a pair in pair management information.

3. The distributed storage system according to claim 2, wherein the pair management module is configured to acquire, when the same hash value is present as a result of the query, data including the same hash value in the another node, compare the data in the another node with the data in the own node, and when the data in the another node with the data in the own node do not match each other, set the one of the logical chunks including the data in the own node and the one of the logical chunks including the data in the another node as different logical chunks in the pair management information without forming a pair therebetween.

4. The distributed storage system according to claim 1, wherein the logical chunk management module is configured to allocate one of the physical chunks within the same node to each of the logical chunks.

5. The distributed storage system according to claim 2, wherein the pair management module is configured to delete, when the write request for the data is a request to update the data, the first identifier from the pair management information to cancel the pair.

6. A control method for a distributed storage system, the distributed storage system including a plurality of nodes coupled to each other, the plurality of nodes each including a processor, a memory, a storage device, and a network interface,
the control method comprising:
managing, by each of the plurality of nodes, physical chunks obtained by dividing a physical storage area of the storage device by a predetermined size;
a logical chunk management step of managing, by the each of the plurality of nodes, as each of logical chunks, a logical storage area to which one or more physical chunks among the physical chunks is allocated;
a volume management step of providing, by the each of the plurality of nodes, a volume to which one or more logical chunks among the logical chunks is allocated, to outside; and
a pair management step of managing, by the each of the plurality of nodes, as a pair, the logical chunks storing the same data among the plurality of nodes,
the volume management step comprising identifying, when a write request for the data is received, one of the logical chunks that forms a designated volume, and transmitting an instruction to write the data to the identified one of the logical chunks,
the logical chunk management step comprising receiving the instruction to write the data to the one of the logical chunks, identifying one of the physical chunks that forms the one of the logical chunks, and transmitting an instruction to write the data to the one of the physical chunks,
the managing of the physical chunks comprising receiving the instruction to write the data to the one of the physical chunks, and writing the data to the identified one of the physical chunks,
the pair management step comprising calculating a hash value of the data, transmitting the hash value to another node, and issuing a query about presence or absence of the same hash value.

7. The control method for a distributed storage system according to claim 6, wherein the pair management step comprises acquiring, when the same hash value is present as a result of the query, an identifier of one of the logical chunks including the same hash value from the another node as a second identifier, setting an identifier of one of the logical chunks in an own node as a first identifier, and setting the first identifier and the second identifier as a pair in pair management information.

8. The control method for a distributed storage system according to claim 7, wherein the pair management step comprises acquiring, when the same hash value is present as a result of the query, data including the same hash value in the another node, comparing the data in the another node with the data in the own node, and when the data in the another node with the data in the own node do not match each other, setting the one of the logical chunks including the data in the own node and the one of the logical chunks including the data in the another node as different logical chunks in the pair management information without forming a pair therebetween.

9. The control method for a distributed storage system according to claim 6, wherein the logical chunk management step comprises allocating one of the physical chunks within the same node to each of the logical chunks.

10. The control method for a distributed storage system according to claim 7, wherein the pair management step comprises deleting, when the write request for the data relates to an update of the data, the first identifier from the pair management information to cancel the pair.

11. A non-transitory computer-readable storage medium having stored thereon a program for controlling each of nodes that includes a processor, a memory, a storage device, and a network interface, to execute:
managing physical chunks obtained by dividing a physical storage area of the storage device by a predetermined size;
a logical chunk management step of managing as each of logical chunks, a logical storage area to which one or more physical chunks among the physical chunks is allocated;
a volume management step of providing a volume to which one or more logical chunks among the logical chunks is allocated, to outside; and
a pair management step of managing, as a pair, the logical chunks storing the same data among the nodes,
the volume management step comprising identifying, when a write request for the data is received, one of the logical chunks that forms a designated volume, and transmitting an instruction to write the data to the identified one of the logical chunks,
the logical chunk management step comprising receiving the instruction to write the data to the one of the logical chunks, identifying one of the physical chunks that forms the one of the logical chunks, and transmitting an instruction to write the data to the one of the physical chunks,
the managing of the physical chunks comprising receiving the instruction to write the data to the one of the physical chunks, and writing the data to the identified one of the physical chunks,
the pair management step comprising calculating a hash value of the data, transmitting the hash value to another node, and issuing a query about presence or absence of the same hash value.

12. The storage medium according to claim 11, wherein the pair management step comprises acquiring, when the same hash value is present as a result of the query, an identifier of one of the logical chunks including the same hash value from the another node as a second identifier, setting an identifier of one of the logical chunks in an own node as a first identifier, and setting the first identifier and the second identifier as a pair in pair management information.

13. The storage medium according to claim 12, wherein the pair management step comprises acquiring, when the same hash value is present as a result of the query, data including the same hash value in the another node, comparing the data in the another node with the data in the own node, and when the data in the another node with the data in the own node do not match each other, setting the one of the logical chunks including the data in the own node and the one of the logical chunks including the data in the another node as different logical chunks in the pair management information without forming a pair therebetween.

14. The storage medium according to claim 11, wherein the logical chunk management step comprises allocating one of the physical chunks within the same node to each of the logical chunks.

15. The storage medium according to claim 12, wherein the pair management step comprises deleting, when the write request for the data relates to an update of the data, the first identifier from the pair management information to cancel the pair.
